(19) United States
(12) Patent Application Publication
(10) Pub. No.: US 2013/0262264 A1
(43) Pub. Date: Oct. 3, 2013

(54) Methods and Apparatus for Online Commerce

(71) Applicant: ZMAGS CORPORATION, Boston, MA (US)

(72) Inventor: Jens Karstoft, Boston, MA (US)

(21) Appl. No.: 13/796,332

(22) Filed: Mar. 12, 2013

Related U.S. Application Data
(60) Provisional application No. 61/609,632, filed on Mar. 12, 2012.

(51) Int. Cl. G06Q 30/06

(52) U.S. Cl. CPC G06Q 30/0633
USPC 705/26.8

(57) ABSTRACT

A method of receiving an order for an item includes displaying a webpage featuring a product, presenting information concerning a selected item, and adding the selected item to an electronic shopping cart for purchase. The information concerning the item is presented in an overlay while partially obscuring the webpage and disabling interactions with the webpage, in response to the selection of the item. The item is added to the electronic shopping cart while continuing to obscure and disable interactions with the webpage, in response to user-generated action (e.g., clicking a button).

### CROSS-REFERENCE TO RELATED APPLICATION

This application claims priority to and the benefit of, and incorporates herein by reference in its entirety, U.S. Provisional Patent Application No. 61/609,632, which was filed on Mar. 12, 2012.

### TECHNICAL FIELD

In various embodiments, the invention relates to electronic commerce, and more particularly, to methods and apparatus for simplifying and streamlining online shopping.

### BACKGROUND

Numerous online commerce sites provide the functionality of an electronic catalog of products. Upon selecting a product of interest, shoppers are directed to a separate page for viewing product details and an additional, separate page upon adding that product to their checkout cart. Requiring shoppers to navigate away from the original page to view product details can cause confusion among shoppers, some of whom may be unable to determine how to purchase the items or return to the original page for further shopping. The confusion may lead to frustration and cause some shoppers to leave the site altogether without making a purchase. For sellers, requiring shoppers to view multiple web pages to make a purchase lowers conversion rates, leading to less revenue and lower profits.

Accordingly, there is a need for improved methods and apparatus that simplify the online shopping experience.

### SUMMARY OF THE INVENTION

Embodiments of the present invention streamline and simplify the online shopping experience by making it easier for shoppers to view product details and purchase items from an online catalog. In some embodiments, the apparatus and methods described herein allow a user to view product details in a product details window while the original page remains open and visible. The user may then add the product to an electronic shopping cart and subsequently return to the original page for further shopping, without ever navigating away from the original page. In general, the apparatus and methods lead to higher conversion rates (i.e., a higher likelihood that the user will purchase a product) and enable higher average order values due to the ease with which users can purchase multiple items, with fewer clicks and web pages visited.

In one aspect, embodiments of the invention relate to a method of receiving an order for an item. The method includes: displaying a webpage featuring a product; in response to the selection of an item on the webpage, presenting information concerning the selected item in an overlay while partially obscuring the webpage and disabling interactions with the webpage; and in response to a user-generated action, adding the selected item to an electronic shopping cart for purchase while continuing to obscure and disable interactions with the webpage.

In certain embodiments, the selection of an item is done through clicking a button or speaking a sound. The user-generated action may include clicking a button or speaking a sound. In one embodiment, presenting information includes darkening the webpage. Adding the item to an electronic shopping cart may include providing a confirmation message in a confirmation window that at least partially obscures the webpage and disables interactions with the webpage. In some embodiments, the method includes closing the overlay and enabling interactions with the webpage in response to an additional user-generated action.

In another aspect, the invention relates to a system for receiving an order for an item. The system includes (i) a display component for displaying a webpage featuring a product and (ii) a user interface. The user interface is configured to: receive a selection of an item on the webpage and in response update the display component to present information concerning the selected item in an overlay while partially obscuring the webpage and disabling interactions with the webpage; and further receive a user-generated action and in response add the selected item to an electronic shopping cart for purchase while the display component continues to obscure and disable interactions with the webpage.

In certain embodiments, the display component includes a browser. The selection of an item may be done through clicking a button or speaking a sound. Likewise, the user-generated action may include clicking a button or speaking a sound. In one embodiment, the user interface is configured to darken the webpage when presenting information concerning the selected item. The user interface may be configured to provide a confirmation message in a confirmation window when the item has been added to the electronic shopping cart, the confirmation window at least partially obscuring the webpage and disabling interactions with the webpage. In various embodiments, the user interface is further configured to close the overlay and enable interactions with the webpage in response to an additional user-generated action.

In another aspect, the invention relates to an article of manufacture having computer-readable program portions embedded thereon for ordering an item. The program portions include instructions for: displaying a webpage featuring a product; in response to the selection of an item on the webpage, presenting information concerning the selected item in an overlay while partially obscuring the webpage and disabling interactions with the webpage; and in response to a user-generated action, adding the selected item to an electronic shopping cart for purchase while continuing to obscure and disable interactions with the webpage.

In certain embodiments, the selection of an item is done through clicking a button or speaking a sound. The user-generated action may include clicking a button or speaking a sound. In one embodiment, presenting information includes darkening the webpage. Adding the item to an electronic shopping cart may include providing a confirmation message in a confirmation window that at least partially obscures the webpage and disables interactions with the webpage. In some embodiments, the program portions include instructions for closing the overlay and enabling interactions with the webpage, in response to an additional user-generated action.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a screenshot of a page in an online catalog browsed by a user, in accordance with an illustrative embodiment of the invention;

FIG. 2 is a screenshot of a product details window accessed by the user and overlaying the original page, in accordance with an illustrative embodiment of the invention;

FIG. 3 is a screenshot of a confirmation window overlaying the original page and informing the user that an item has been added to an electronic shopping cart, in accordance with an illustrative embodiment of the invention;

FIG. 4 is a screenshot of a checkout screen viewed by the user prior to purchasing the items in the electronic shopping cart, in accordance with an illustrative embodiment of the invention;

FIG. 5 is a flowchart of a method of purchasing a product from an online catalog, in accordance with an illustrative embodiment of the invention;

FIG. 6 shows an example of a computer system suited to providing embodiments of the present invention; and

FIG. 7 illustrates an example of a distributed system including an online catalog system in accordance with an illustrative embodiment of the invention.

### DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art while still remaining within the scope of the invention as described and claimed.

Throughout the description, where apparatus and systems are described as having, including, or comprising specific components, or where processes and methods are described as having, including, or comprising specific steps, it is contemplated that, additionally, there are apparatus and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

In various embodiments, the methods and apparatus described herein allow an online shopper to browse a web page for a product on an electronic commerce site, view details for a particular product, and add the product to a shopping cart, all without navigating away from the original web page. For example, when viewing the online catalog, the shopper may identify a particular product of interest and provide input (e.g., a mouse click or a voice command) to view details for the product. Upon receipt of the input, a product details window is displayed over the original webpage that lists details for the product, which may include one or more images of the product. From the product details window, the user may add the item to an electronic shopping cart or bag and/or proceed to checkout without navigating away from the original webpage. In one embodiment, the original webpage is displayed in the background, beneath the product details window.

In certain embodiments, the product details window is displayed as a “lightbox,” i.e., a modal dialog overlaying the original webpage which requires the user to interact with the dialog before returning the user to the original webpage. For example, a user who is browsing a page in an online catalog may select a link to purchase a product on that page, which causes the product details window to be displayed in an overlay to the current page, instead of causing a new page to load. While the product details window is displayed, the underlying web page (i.e., the original page in the online catalog) may be darkened and/or temporarily disabled to focus the user on the overlay. The product details page may be animated and/or positioned and sized according to the user's browser window.

In some embodiments, the product details window includes a link that allows the user to add the product to the user's electronic shopping cart. To perform this task, the user's web browser may make an AJAX call, for example, to an “add to cart” function of the website, to add the product to the user's shopping cart. The user may then be presented with the option to continue shopping using the online catalog or to proceed to checkout. If the user continues shopping, the product details window disappears and the user is automatically returned to the original underlying online catalog page.

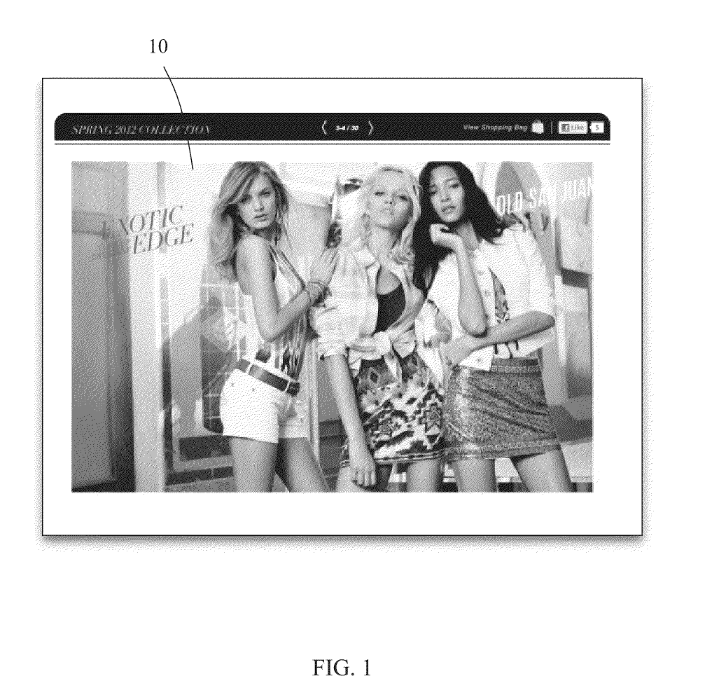

Referring to FIG. 1, in certain embodiments, a user visits a webpage 10 of an online catalog where users may browse through different catalog pages in an inspirational shopping experience. The user may select a product on the webpage 10 to obtain more information concerning a product.

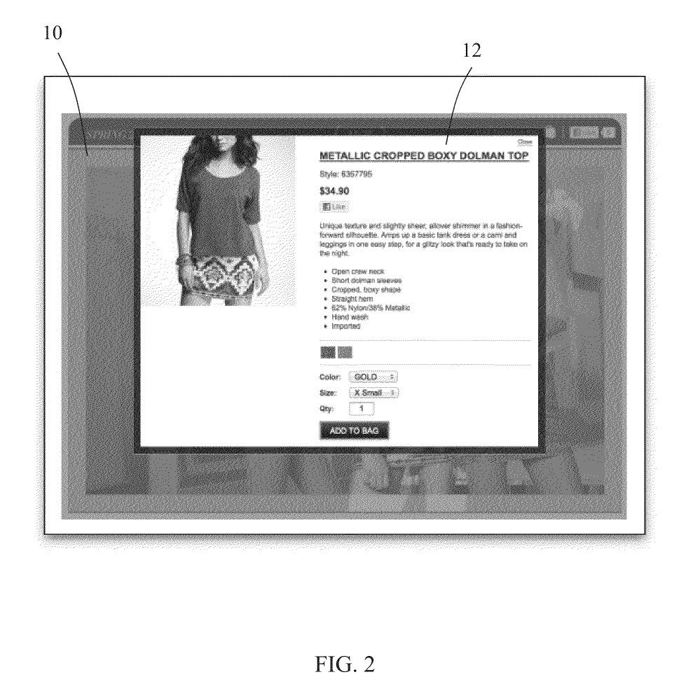

Referring to FIG. 2, after the user has selected the product, the website displays additional information about the product in a product details window 12. In general, the product details window 12 provides information about the product (e.g., images, sizes, cost, and reviews) that the user may use when making a purchasing decision. For example, using the product information, the user may choose to add the product to the shopping cart and/or select particular options associated with the product, such as size or color. In the depicted embodiment, the product details window 12 is displayed as an overlay or lightbox on the original online catalog 10, which is darkened. If a user chooses to close the product details window 12, the user may be automatically returned to the original webpage 10, without any further action from the user.

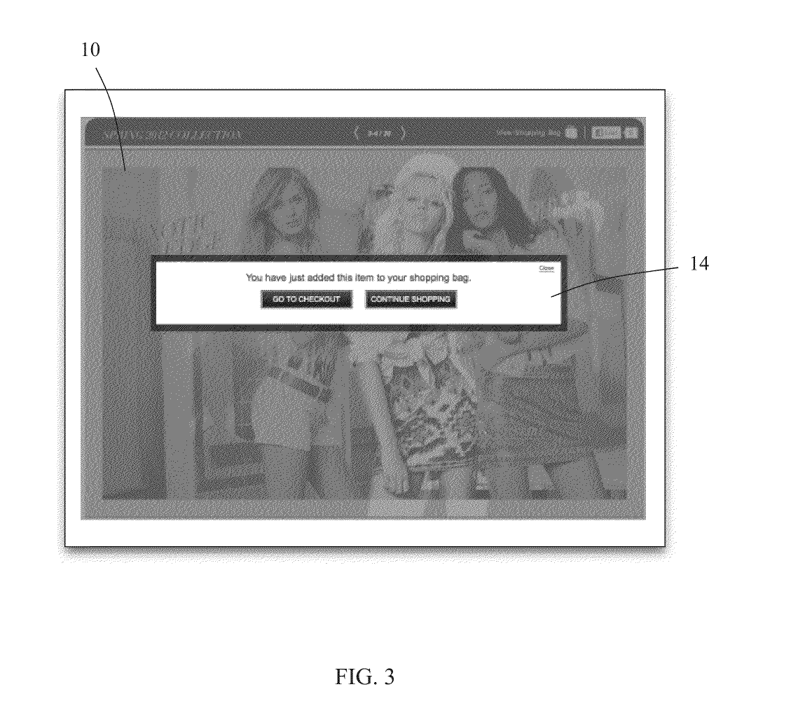

Referring to FIG. 3, in some embodiments, when the user chooses to add the product to their shopping cart, an AJAX call is made to the website's “add to cart” URL. The call may include configurable variables to effectively present the same call that would otherwise be made on a separate product details page of the e-commerce engine. Once the product is added to the cart, a confirmation message is shown to the user. The confirmation message may be provided in a confirmation window or lightbox 14, with the original webpage 10 still darkened and displayed in the background. At this point, the confirmation window 14 gives the user the option to continue shopping or proceed to the shopping cart or checkout page. If the user elects to continue shopping, the confirmation window 14 disappears and the underlying original webpage 10 is automatically reactivated.

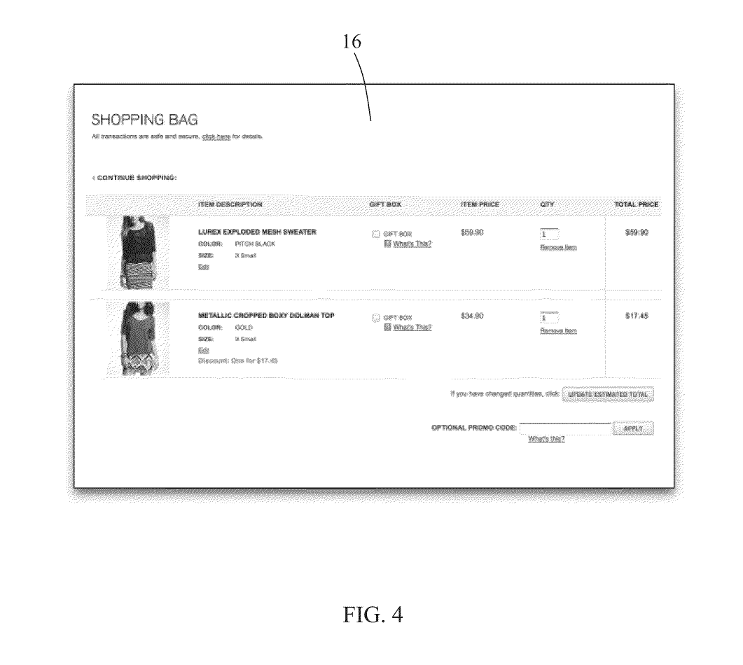

Referring to FIG. 4, in certain embodiments, when the user elects to proceed to checkout, the user is automatically directed to a checkout page 16 for the e-commerce engine. In this instance, the user may be navigated away from the original webpage, such that the catalog page is no longer displayed (e.g., as a darkened background). The checkout page may therefore represent the first time since the beginning of the shopping experience that the catalog page is no longer visible on the display.

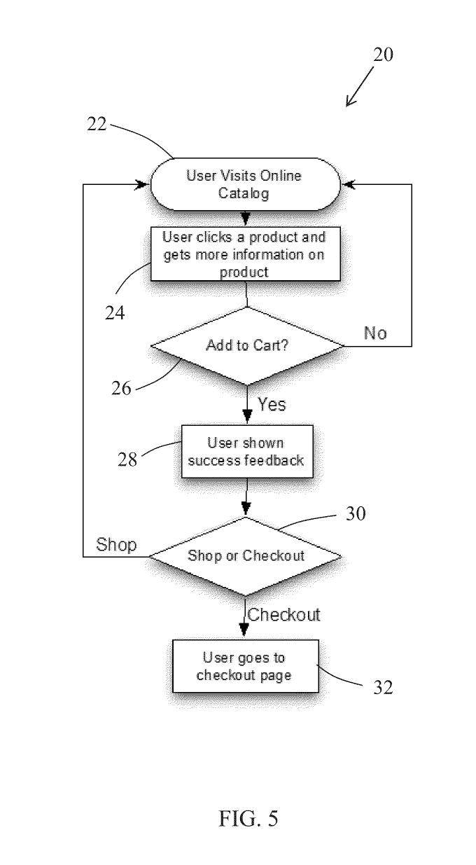

FIG. 5 is a flowchart of a method 20 of online shopping, in accordance with certain embodiments of the invention. The method 20 begins when a user visits an online catalog website (step 22). While browsing products in the catalog, the user may select or click on a product (step 24) to obtain more information about the product. As mentioned above, the information may be presented in a product details window as an overlay or lightbox on the original webpage presenting the product. The user then has the option of adding the product to their electronic shopping cart (step 26). If the user decides not to add the product to the cart, the overlay/lightbox is closed and the user is returned to the original product webpage. Alternatively, if the user chooses to add the product to the cart, the user is provided with feedback (e.g., in the confirmation window) indicating that the item has been successfully added to the cart (step 28). At this point, the user has the option of continuing to shop or proceeding to checkout (step 30). If the user chooses to continue shopping, the user is returned to the original product webpage. For example, the confirmation window may disappear to reveal the original product webpage, which was previously inactive and darkened. Alternatively, if the user chooses to proceed to checkout, the user is directed to a checkout page (step 32). As mentioned, this may be the first time during the shopping experience that the user is navigated away from the online catalog, such that the original product webpage is no longer displayed.

### Computer System

Various aspects and functions described herein in accord with the present invention may be implemented as hardware or software on one or more computer systems. There are many examples of computer systems in use currently including network appliances, personal computers, workstations, mainframes, networked clients, servers, media servers, application servers, database servers and web servers. Other examples of computer systems may include mobile computing devices, such as cellular phones, personal digital assistants, and network equipment, such as load balancers, routers and switches. Further, aspects in accord with the present invention may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

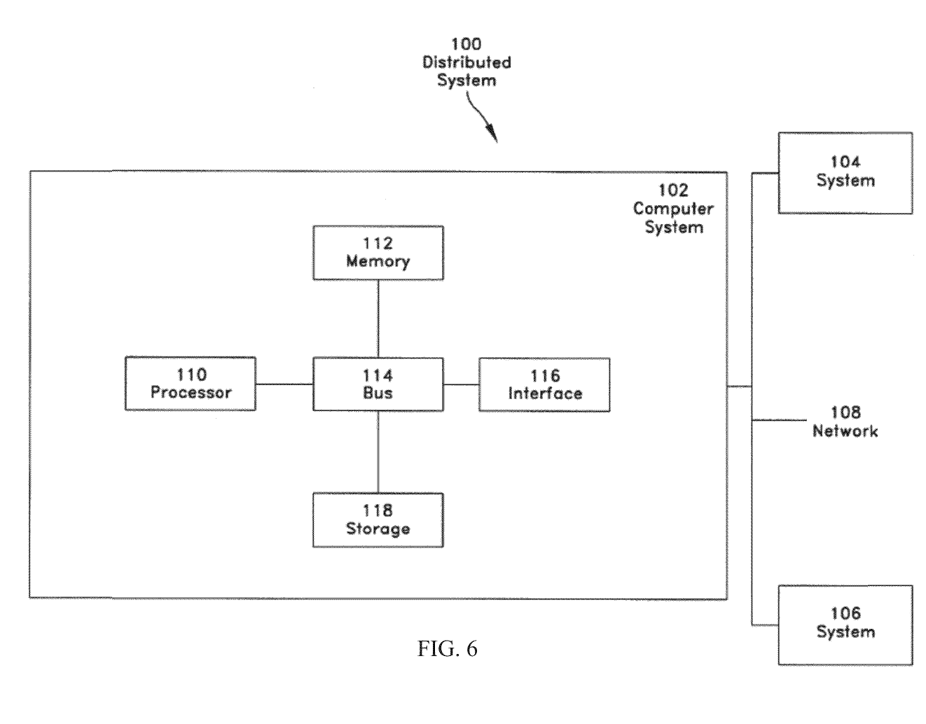

FIG. 6 shows a block diagram of a distributed computer system 100, in which various aspects and functions in accord with the present invention may be practiced. Distributed computer system 100 may include one more computer systems. For example, as illustrated, distributed computer system 100 includes computer systems 102, 104 and 106. As shown, computer systems 102, 104 and 106 are interconnected by, and may exchange data through, communication network 108. Network 108 may include any communication network through which computer systems may exchange data. To exchange data using network 108, computer systems 102, 104 and 106 and network 108 may use various methods, protocols and standards, including, among others, token ring, Ethernet, TCP/IP, UDP, HTTP, FTP, and SNMP. To ensure data transfer is secure, computer systems 102, 104 and 106 may transmit data via network 108 using a variety of security measures including TLS or SSL among other security techniques. While distributed computer system 100 illustrates three networked computer systems, distributed computer system 100 may include any number of computer systems and computing devices, networked using any medium and communication protocol.

Various aspects and functions in accord with the present invention may be implemented as specialized hardware or software executing in one or more computer systems including computer system 102 shown in FIG. 6. As depicted, computer system 102 includes processor 110, memory 112, bus 114, interface 116 and storage 118. Processor 110 may perform a series of instructions that result in manipulated data. Processor 110 may be a commercially available processor such as an Intel Core, Motorola PowerPC, MIPS, U1traSPARC, or Hewlett-Packard PA-RISC processor, but may be any type of processor or controller as many other processors and controllers are available. Processor 110 is connected to other system elements, including one or more memory devices 112, by bus 114.

Memory 112 may be used for storing programs and data during operation of computer system 102. Thus, memory 112 may be a relatively high performance, volatile, random access memory such as a dynamic random access memory (DRAM) or static memory (SRAM). However, memory 112 may include any device for storing data, such as a disk drive or other non-volatile storage device. Various embodiments in accord with the present invention may organize memory 112 into particularized and, in some cases, unique structures to perform the aspects and functions disclosed herein.

Components of computer system 102 may be coupled by an interconnection element such as bus 114. Bus 114 may include one or more physical busses (for example, between components that are integrated within a same machine), but may include any communication coupling between system elements including specialized or standard computing bus technologies such as IDE, SCSI, PCI and InfiniBand. Thus, bus 114 enables communications (for example, data and instructions) to be exchanged between system components of computer system 102.

Computer system 102 also includes one or more interface devices 116 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow computer system 102 to exchange information and communicate with external entities, such as users and other systems.

Storage system 118 may include a computer readable and writeable nonvolatile storage medium in which instructions are stored that define a program to be executed by the processor. Storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor or some other controller may cause data to be read from the nonvolatile recording medium into another memory, such as memory 112, that allows for faster access to the information by the processor than does the storage medium included in storage system 118. The memory may be located in storage system 118 or in memory 112, however, processor 110 may manipulate the data within the memory 112, and then copy the data to the medium associated with storage system 118 after processing is completed. A variety of components may manage data movement between the medium and integrated circuit memory element and the invention is not limited thereto. Further, the invention is not limited to a particular memory system or storage system.

Although computer system 102 is shown by way of example as one type of computer system upon which various aspects and functions in accord with the present invention may be practiced, aspects of the invention are not limited to being implemented on the computer system as shown in FIG. 6. Various aspects and functions in accord with the present invention may be practiced on one or more computers having a different architectures or components than that shown in FIG. 6. For instance, computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

Computer system 102 may be a computer system including an operating system that manages at least a portion of the hardware elements included in computer system 102. Usually, a processor or controller, such as processor 110, executes an operating system which may be, for example, a Windows-based operating system (for example, Windows 7, Windows 2000 (Windows ME), Windows XP operating systems) available from the Microsoft Corporation, a MAC OS System X operating system available from Apple Computer, one of many Linux-based operating system distributions (for example, the Enterprise Linux operating system available from Red Hat Inc.), or a UNIX operating system available from various sources. Many other operating systems may be used, and embodiments are not limited to any particular implementation.

The processor and operating system together define a computer platform for which application programs in high-level programming languages may be written. These component applications may be executable, intermediate (for example, C-) or interpreted code which communicate over a communication network (for example, the Internet) using a communication protocol (for example, TCP/IP). Similarly, aspects in accord with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from MySQL AB of Uppsala, Sweden or integration software such as Web Sphere middleware from IBM of Armonk, N.Y. However, a computer system running, for example, SQL Server may be able to support both aspects in accord with the present invention and databases for sundry applications not within the scope of the invention.

### Example System Architecture

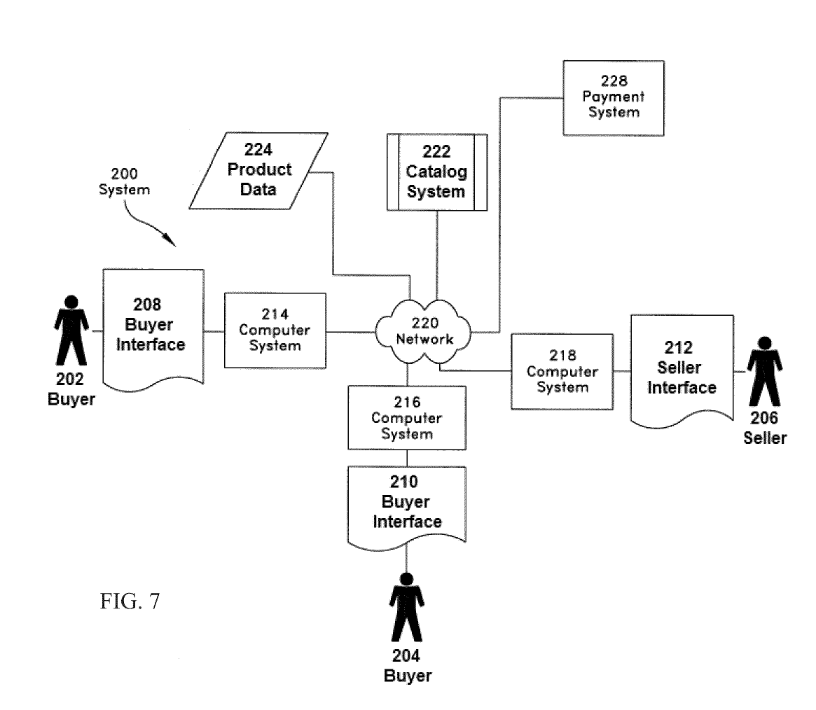

FIG. 7 presents a context diagram of a distributed system 200 configured to provide an online catalog platform in accord with the present invention. Referring to FIG. 7, system 200 may include buyers 202 and 204, a seller 206, buyer interfaces 208 and 210, seller interface 212, computer systems 214, 216 and 218, communications network 220, catalog system 222, product data 224, and payment system 228. System 200 may allow buyers 202 and 204 to interact with buyer interfaces 208 and 210, respectively. Similarly, system 200 may allow seller 206 to interact with seller interface 212. System 200 may also catalog system 222 to interact with payment system 228 and receive product data 224.

According to the depicted embodiment, interfaces 208, 210 and 212 may be browser-based user interfaces served by catalog system 222 and may be rendered by computer systems 214, 216 and 218. Computer systems 214, 216 and 218 may be interconnected with one another and catalog system 222 via network 220. Network 220 may include any communication network through which member computer systems may exchange data.

The sundry computer systems shown in FIG. 7, which include computer systems 214, 216 and 218, network 220, catalog system 222, and payment system 228, each may include one or more computer systems. As discussed above with regard to FIG. 6, computer systems may have one or more processors or controllers, memory and interface devices. The particular configuration of system 200 depicted in FIG. 7 is used for illustration purposes only and embodiments of the invention may be practiced in other contexts. Thus, the invention is not limited to a specific number of users or systems.

Catalog system 222 may manage transactions between one or more sellers and one or more buyers, such as seller 206 and buyers 202 and 204. In the illustrated embodiment, catalog system 222 may provide buyer interfaces 208 and 210 to buyers 202 and 204, respectively. Catalog system 222 may also provide seller interface 212 to seller 206. Interfaces 208, 210 and 212 may be presented to users 202, 204 and 206 via network 220 on computer systems 214, 216 and 218, respectively. As discussed herein, catalog system 222 may enable buyers 202 and 204 to view product details and add items to electronic shopping carts, without leaving or browsing away from an online catalog.

In various embodiments, catalog system 222 may receive product data 224 from a variety of sources and may use it in transactions involving the buyers 202 and 204 and the seller 206. Product data 224 may include any current or past data related to items that are presented in the online catalog. Examples of product data 224 include, among other data, price data, product features, product descriptions (e.g., sizes, weights, colors), photographs, product reviews, related products, product availability, seller information, and shipping information (e.g., available discounts).

In other embodiments, catalog system 222 may exchange data with payment system 228 to clear and settle transactions between the buyers 202 and 204 and the seller 206. This data exchange may include requests for payment from the buyers 202 and 204. These requests for payment may result in funds transferred from the buyers 202 and 204 to the seller 206.

According to another embodiment, a third party, such as a financial institution or system service provider, acts as a financial intermediary between buyers and sellers. In this embodiment, catalog system 222 may request that payment system 228 transfer funds from the buyer to the financial intermediary. The financial intermediary may then transfer the funds from this and other buyers to the seller in a series of transactions. In this way, the anonymity of the buyers may be preserved, i.e., the seller may not know the identity of particular buyers.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method of receiving an order for an item, the method comprising:
displaying a webpage featuring a product;
in response to the selection of an item on the webpage, presenting information concerning the selected item in an overlay while partially obscuring the webpage and disabling interactions with the webpage; and
in response to a user-generated action, adding the selected item to an electronic shopping cart for purchase while continuing to obscure and disable interactions with the webpage.

2. The method of claim 1, wherein the selection of an item is done through clicking a button or speaking a sound.

3. The method of claim 1, wherein the user-generated action comprises clicking a button or speaking a sound.

4. The method of claim 1, wherein presenting information comprises darkening the webpage.

5. The method of claim 1, wherein adding the item to an electronic shopping cart comprises providing a confirmation message in a confirmation window that at least partially obscures the webpage and disables interactions with the webpage.

6. The method of claim 1, further comprising closing the overlay and enabling interactions with the webpage in response to an additional user-generated action.

7. A system for receiving an order for an item comprising:
a display component for displaying a webpage featuring a product; and
a user interface configured to:
receive a selection of an item on the webpage and in response update the display component to present information concerning the selected item in an overlay while partially obscuring the webpage and disabling interactions with the webpage; and
further receive a user-generated action and in response add the selected item to an electronic shopping cart for purchase while the display component continues to obscure and disable interactions with the webpage.

8. The system of claim 7, wherein the display component comprises a browser.

9. The system of claim 7, wherein the selection of an item is done through clicking a button or speaking a sound.

10. The system of claim 7, wherein the user-generated action comprises clicking a button or speaking a sound.

11. The system of claim 7, wherein the user interface is configured to darken the webpage when presenting information concerning the selected item.

12. The system of claim 7, wherein the user interface is configured to provide a confirmation message in a confirmation window when the item has been added to the electronic shopping cart, the confirmation window at least partially obscuring the webpage and disabling interactions with the webpage.

13. The system of claim 7, wherein the user interface is further configured to close the overlay and enable interactions with the webpage in response to an additional user-generated action.

14. An article of manufacture having computer-readable program portions embedded thereon for ordering an item, the program portions comprising instructions for:
displaying a webpage featuring a product;
in response to the selection of an item on the webpage, presenting information concerning the selected item in an overlay while partially obscuring the webpage and disabling interactions with the webpage; and
in response to a user-generated action, adding the selected item to an electronic shopping cart for purchase while continuing to obscure and disable interactions with the webpage.

15. The article of claim 14, wherein the selection of an item is done through clicking a button or speaking a sound.

16. The article of claim 14, wherein the user-generated action comprises clicking a button or speaking a sound.

17. The article of claim 14, wherein presenting information comprises darkening the webpage.

18. The article of claim 14, wherein adding the item to an electronic shopping cart comprises providing a confirmation message in a confirmation window that at least partially obscures the webpage and disables interactions with the webpage.

19. The article of claim 14, wherein the program portions comprise instructions for closing the overlay and enabling interactions with the webpage, in response to an additional user-generated action.
